(19) United States
(12) Patent Application Publication
(10) Pub. No.: US 2024/0343420 A1
(43) Pub. Date: Oct. 17, 2024

(54) WATCH-TYPE DRONE, REMOTE CONTROL THEREOF, AND OPERATING METHOD THEREOF

(71) Applicant: GANG YAO, SHENZHEN (CN)

(72) Inventor: GANG YAO, SHENZHEN (CN)

(21) Appl. No.: 18/313,503

(22) Filed: May 8, 2023

(30) Foreign Application Priority Data
Apr. 14, 2023 (CN) 202320845507.1

(51) Int. Cl. B64U 10/14; A44C 5/00; B64U 20/80; B64U 80/60; G05D 1/00; G05D 1/08

(52) U.S. Cl. CPC B64U 10/14; A44C 5/0053; B64U 20/80; B64U 80/60; B64U 2201/20; G04B 47/00; H05K 7/1427

(57) ABSTRACT

A watch-type drone, a remote control thereof, an operating method thereof relating to a technical field of drones are provided. The watch-type drone includes a watchband, a remote control detachably arranged on the watchband, a storage box defining a receiving space, and a drone placed in the receiving space. An accommodating space is defined in the remote control. A bottom portion of the storage box is magnetically connected to the remote control. The remote control includes a main control board and a button assembly. The main control board is mounted in the accommodating space. The button assembly is mounted on two sides of the main control board and is electrically communicated with the main control board. Through holes are defined on two sides of the remote control. The button assembly configured to control a flight path and a flight speed of the drone is exposed from the through holes.

### TECHNICAL FIELD

The present disclosure relates to a technical field of drones, and in particular to a watch-type drone, a remote control thereof, and an operating method thereof.

### BACKGROUND

At present, watch-type drones are getting more and more attention because of small size, easy to carry, and convenient for aerial photography at any time. However, when using a watch-type drone, a separate watch-type drone controller is needed to control flight of the watch-type drone, which is troublesome to operate. In order to facilitate control of a drone, Chinese patent No. CN 113552901 A provides a wristwatch-type controller, which uses a control rocker to control a flight direction of the drone. Because the wristwatch-type controller is small in size, the control rocker arranged on the wristwatch-type controller is also relatively small, making the control rocker difficult to control. Moreover, the control rocker is exposed on a top portion of the wristwatch-type controller, so the control rocker is not well protected and the control rocker is easy to be damaged.

### SUMMARY

A purpose of the present disclosure is to solve defects in the prior art. The present disclosure provides a watch-type drone that uses a button assembly to control a flight path and a flight speed of a drone, or controls a flight direction of the drone by tilting a remote control worn on a wrist, which is easy to operate and has high reliability.

To achieve the above purpose, the present disclosure provides the watch-type drone. The watch-type drone comprises a watchband, a remote control detachably arranged on the watchband, a storage box defining a receiving space, and a drone placed in the receiving space. An accommodating space is defined in the remote control. A bottom portion of the storage box is magnetically connected to the remote control. The remote control comprises a main control board and a button assembly. The main control board is mounted in the accommodating space. The button assembly is mounted on two sides of the main control board and is electrically communicated with the main control board. Through holes are defined on two sides of the remote control. The button assembly is exposed from the through holes. The button assembly is configured to control a flight path and a flight speed of the drone. In the embodiment, the button assembly is configured to control a flight of the drone, which is easy to operate and has high reliability.

In one embodiment, the button assembly comprises a button A, a button B, a button C, and a button D. The button A and the button B are arranged on a first side of the remote control. The button C and the button D are arranged on a second side of the remote control. When the button B and the button D are short pressed: the drone is controlled to roll over. When the button B and the button D are long pressed, the remote control is controlled to enter a time adjustment mode. When the button A and the button C are short pressed, the drone is hovered. When the button A and the button C are long pressed, the drone is turned on/turned off.

In one embodiment, when the button A is short pressed, the drone is controlled to rise. When the button A is short pressed twice, the drone is controlled to fly forward in a fine-tuning mode. When the button A is long pressed, the drone is controlled to take off. When the button A is long pressed twice, the drone is controlled to land. When the button B is short pressed, the drone is controlled to rotate to left or finely adjust to the left. When the button B is long pressed, the drone is calibrated. When the button C is short pressed, the drone is controlled to descend. When the button C is short pressed twice, the drone is controlled to fly backward in the fine-tuning mode. When the button D is short pressed, the drone is controlled to rotate to right or finely adjust to the right. When the button D is short pressed, the flight speed of the drone is controlled to switch between a high speed mode and a low speed mode.

In one embodiment, the remote control further comprises a gyroscope sensor communicated with the main control board. During operation, when the remote control is tilted forward, the drone flies forward. When the remote control is tilted backward, the drone flies backward. When the remote control is tilted leftward, the remote controlled to fly f toward left. When the remote control is tilted rightward, the drone is controlled to fly toward right. Thus, the drone is easy to control and the flight of the drone is easy to control.

In one embodiment, a communication protocol between the remote control and the drone is selected from one of a WIFI protocol, a ZigBee protocol, and a GPRS protocol.

In one embodiment, the drone comprises a fixing base. A printed circuit board (PCB) control board is arranged in the fixing base. First fixing holes are defined on four corner directions of the fixing base. Four motors are one-to-one mounted in the first fixing holes and are communicated with the PCB control board. A rotor wing is fixed on an output shaft arranged on a top portion of each of the motors. A first power supply electrically connected to the PCB control board and the motors is arranged on a bottom portion of the fixing base.

In one embodiment, the storage box comprises a box body defining the receiving space and a cover body. The cover body is fixed to a top portion of the box body and is configured to seal the receiving space. Four circular fixing grooves configured to position the motors are defined in the receiving space.

In one embodiment, first magnets are arranged on a bottom portion of the box body.

In one embodiment, the watchband is windable to be worn on a wrist, which is easy to wear. Further, the watchband is replaceable, which improves aesthetics.

The present disclosure further provides a remote control applied to the watch-type drone mentioned above. The remote control comprises a display electrically communicated with the main control board. The display is configured to display time.

In one embodiment, the remote control comprises a second power supply. The Second power supply is configured to power the main control board and the display. A charging interface configured to charge the second power supply is arranged on a bottom portion of the remote control.

In one embodiment, second magnets are arranged in the remote control. The second magnets are magnetically connected with the storage box.

In one embodiment, at least two second fixing holes matched with the watchband are defined on the bottom portion of the remote control. The watchband is inserted into the second fixing holes.

In one embodiment, the remote control comprises a lower shell and an upper shell. The second fixing holes are defined on the lower shell. The lower shell and the upper shell are connected to form the accommodating space and the through holes on the two sides of the remote control. A first opening configured to mount the charging interface is defined on a bottom portion of the lower shell. Four L-shaped positioning columns are arranged on a middle portion of the lower shell to form a rectangular fixing groove. The rectangular fixing groove is configured to mount the second power supply. First cylindrical positioning columns are respectively arranged on a left end and a right end of the lower shell. The first cylindrical positioning columns are configured to fix the button assembly. Second cylindrical positioning columns are respectively arranged on a front end and a rear end of the lower shell. The second cylindrical positioning columns are configured to fix the second magnets. A first bearing portion is arranged on one side of each of the first cylindrical positioning columns close to the rectangular fixing groove. Second bearing portions are arranged on two sides of each of the second cylindrical positioning columns. A middle portion of the main control board is fixed to top portions of the L-shaped positioning columns. A left side of the main control board and a right side of the main control board are respectively fixed to a top portion of a corresponding first bearing portion. A front side of the main control board and a rear side of the main control board are fixed to top portions of the second bearing portions. A second opening configured to fix the display is defined on a middle portion of the upper shell. A structure of the remote control is simple and the remote control is easy to assemble.

In one embodiment, the button assembly comprises button bodies and two button cap assemblies. The button bodies are arranged on two sides of the main control board and are communicated with the main control board. The button cap assemblies are arranged on two ends of the remote control. Each of the button cap assemblies comprises two button caps and button cap bodies connected to the two button caps. A mounting hole is defined on a middle portion of each of the button cap bodies. An inserting groove is defined on a middle portion of each of the first cylindrical positioning columns. Fixing columns are arranged on a bottom portion of the upper shell. Each of the fixing columns is matched with a corresponding inserting groove. Each of the fixing columns passes through a corresponding mounting hole and is fixed in the corresponding inserting groove.

In one embodiment, hook portions are arranged on the lower shell. Snap portions matched with the hook portions are arranged on the upper shell. The hook portions are respectively snapped on the snap portions to fixedly connect the lower shell and the upper shell.

The present disclosure further provides an operating method of the watch-type drone mentioned above. The operating method comprise:
S1: fixing the remote control on the watchband, and then fixing the watchband to a wrist;
S2: opening the storage box, taking out the drone, placing the drone on a horizontal ground or on a platform, pressing the button B and performing code matching and calibration on the drone; and completing the code matching and calibration of the drone after the drone flashes a light and after the remote control emits a beeping sound; and
S3: long pressing the button A, so the drone is taken off; controlling the flight path of the drone by pressing different buttons.

Compared with the prior art, in the present disclosure, the flight path and the flight speed of the drone are controlled by the button assembly, and no additional remote control is needed to control the flight of the drone. Alternatively, the flight direction of the drone is also controlled by controlling a tilt direction of the remote control worn on the wrist, which is simple and convenient to operate. Further, the remote control of the present disclosure is able to control similar aircraft, remote control cars, and other toys.

In the present disclosure, the remote control and the storage box where the drone is accommodated are magnetically connected, so the storage box is easy to remove/assemble. In addition, the remote control comprises the display displaying the time, so the remote control of the present disclosure acts as a watch to check the time, is also able to control same type of toys, and has multiple functions.

The watchband of the present disclosure is first inserted into the remote control, and then is automatically enwound so that the remote control is fixed on the wrist, which not only makes the remote control simple and convenient to wear, but also is convenient to replace the watchband or wear a DIY watchband made by a user. Therefore, the watchband is aesthetically pleasing and unique.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of a watch-type drone of the present disclosure shown in a storage state.

FIG. 2 is a structural schematic diagram of the watch-type drone of the present disclosure shown in an open state.

FIG. 3 is a structural schematic diagram of a drone of the present disclosure.

FIG. 4 is a structural schematic diagram of a storage box of the present disclosure.

FIG. 5 is another structural schematic diagram of a storage box of the present disclosure.

FIG. 6 is an exploded schematic diagram of a remote control of the present disclosure.

FIG. 7 is another exploded schematic diagram of the remote control of the present disclosure.

FIG. 8 is a structural schematic diagram of a lower shell of the present disclosure.

FIG. 9 is a structural schematic diagram of an upper shell of the present disclosure.

FIG. 10 is a structural schematic diagram of the remote control of the present disclosure where button cap assemblies are removed.

FIG. 11 is a structural schematic diagram of the watchband and the remote control of the present disclosure where the watchband is assembled with the remote control.

FIG. 12 is a structural schematic diagram of a button assembly of the present disclosure.

In the drawings:

1—Watchband; 2—remote control; 21—lower shell; 211—L-shaped positioning column; 212—Rectangular fixing groove; 213—First Cylindrical Positioning Column; 2131—inserting groove; 214—second cylindrical positioning column; 215—first bearing portion; 216—second bearing portion; 217—second fixing hole; 218—hook portion; 22—main control board; 23—button assembly; 231—button body; 232—button cap assembly; 2321—mounting hole; 24—through hole; 25—display; 26—upper shell; 261—snap portion; 262—fixing column; 27—second power supply; 28—charging interface; 29—second magnet; 3—storage box; 31—box body; 311—rectangular positioning portion; 32—cover body; 33—circular fixing groove; 34—first magnet; 4—drone; 41—fixing base; 411—first fixing hole; 42—motor; 43—rotor wing; 44—first power supply.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be noted that all directional indications in the embodiments of the present disclosure (such as up, down, left, right, front, back, etc.) are only used to explain the relative position relationship the motion situation, etc. between the components under a certain specific posture (as shown in the drawings), and if the specific posture changes, the directional indications also change accordingly.

It should be noted in the description of the present disclosure that, unless otherwise regulated and defined, terms such as “connection” and “fix” shall be understood in broad sense, and for example, may refer to fixed connection or detachable connection or integral connection; may refer to mechanical connection or electrical connection; and may refer to direct connection or indirect connection through an intermediate medium or inner communication of two elements. For those of ordinary skill in the art, the meanings of the above terms in the present disclosure may be understood according to concrete conditions.

It should be understood in the embodiments of the present disclosure that terms such as “first” and “second” are only used for the purpose of description, rather than being understood to indicate or imply relative importance or hint the number of indicated technical features. Thus, the feature limited by “first” and “second” can explicitly or impliedly include one or more features. In addition, the term “and/or” depict relationship between associated objects and there are three relationships thereon. For example, A and/or B may indicate A exists alone, A and B exist at the same time, and B exists alone. In addition, the technical solutions between the various embodiments may be combined with each other, but the combination should be realized by those skilled in the art. When the combination of the technical solutions is contradictory or cannot be implemented, it should be considered that the combination of the technical solutions does not exist or is not within the protection scope of the present disclosure.

### Embodiment 1

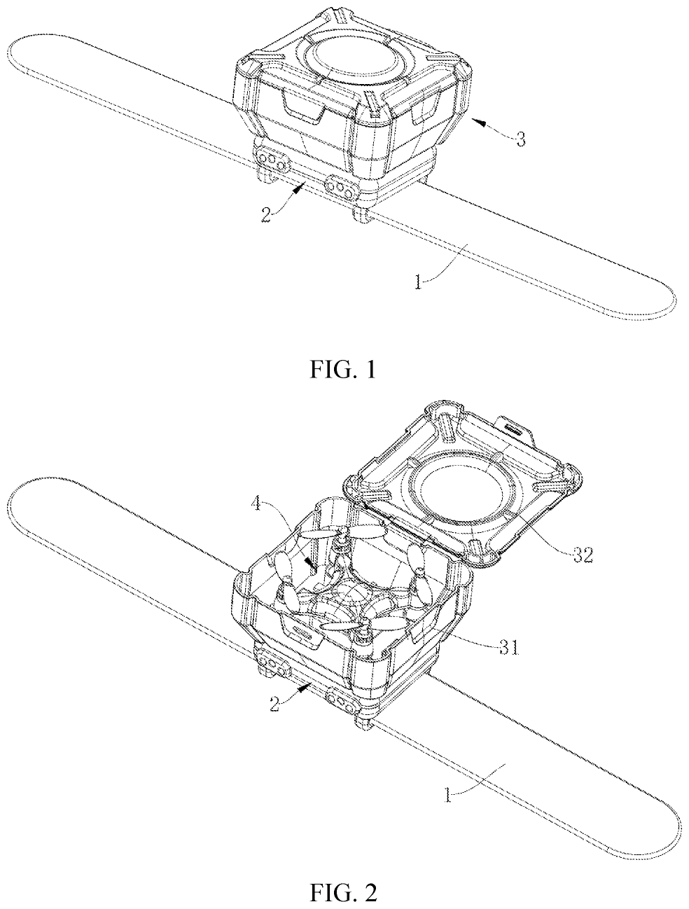

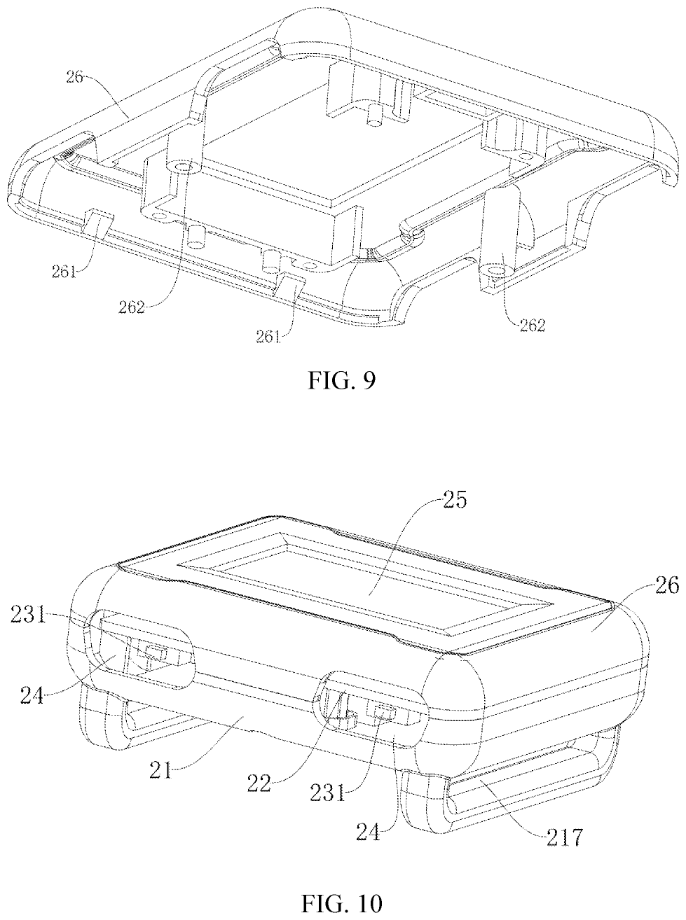

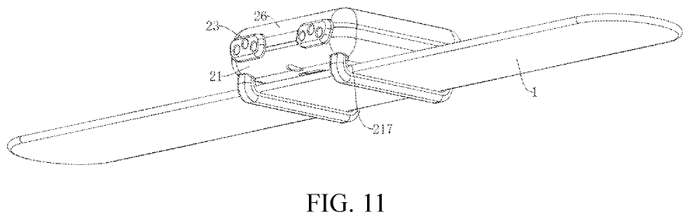

As shown in FIGS. 1-12, the present disclosure provides a watch-type drone. The watch-type drone comprises a watchband 1, a remote control 2, a storage box 3, and a drone 4. An accommodating space is defined in the remote control 2. The remote control 2 is detachably arranged on the watchband 1. The storage box 3 defines a receiving space, and the drone 4 is placed in the receiving space. Optionally, first magnets 34 are arranged on a bottom portion of the storage box 3, and second magnet 29 are arranged in the remote control 2. The first magnets 34 are matched with the second magnets 29. When in use, the bottom portion of the storage box 3 is magnetically connected to the remote control 2, making it easy to remove/assemble the remote control 2.

The remote control 2 comprises a main control board 22 and a button assembly 23. The main control board 22 is mounted in the accommodating space. The button assembly 23 is mounted on two sides of the main control board 22 and is electrically communicated with the main control board 22. Through holes 24 are defined on two sides of the remote control 2. The button assembly 23 is exposed from the through holes 24. The button assembly 23 is configured to control a flight path and a flight speed of the drone.

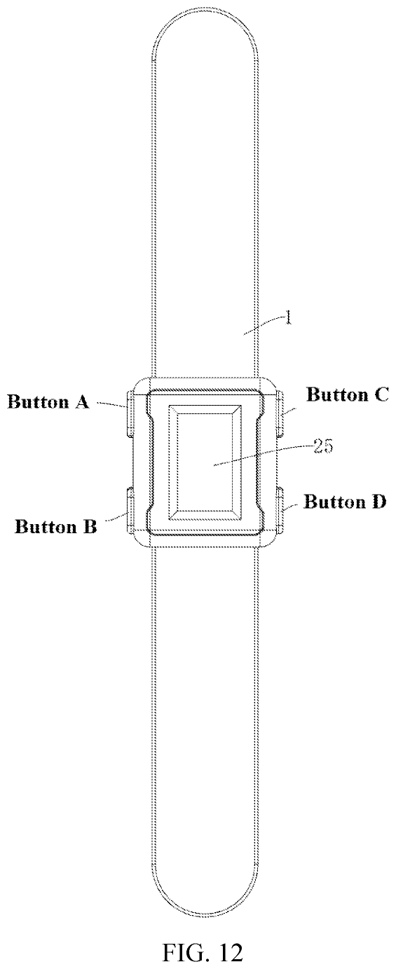

As shown in FIG. 12, the button assembly 23 comprises a button A, a button B, a button C, and a button D. The button A and the button B are arranged on a first side of the remote control 2. The button C and the button D are arranged on a second side of the remote control 2. When the button B and the button D are short pressed: the drone 4 is controlled to roll over. When the button B and the button D are long pressed, the remote control 2 is controlled to enter a time adjustment mode. When the button A and the button C are short pressed, the drone 4 is hovered. When the button A and the button C are long pressed, the drone 4 is turned on/turned off. When the button A is short pressed, the drone 4 is controlled to rise. When the button A is short pressed twice, the drone 4 is controlled to fly forward in a fine-tuning mode. When the button A is long pressed, the drone 4 is controlled to take off. When the button A is long pressed twice, the drone 4 is controlled to land. When the button B is short pressed, the drone 4 is controlled to rotate to left or finely adjust to the left. When the button B is long pressed, the drone 4 is calibrated. When the button C is short pressed, the drone is controlled to descend. When the button C is short pressed twice, the drone 4 is controlled to fly backward in the fine-tuning mode. When the button D is short pressed, the drone 4 is controlled to rotate to right or finely adjust to the right. When the button D is short pressed, the flight speed of the drone 4 is controlled to switch between a high speed mode and a low speed mode.

Optionally, in the embodiment, the remote control 2 further comprises a gyroscope sensor communicated with the main control board 22. During operation, when the remote control 2 is tilted forward, the gyroscope sensor senses a forward signal and sends the forward signal to the main control board 22, and the main control board controls the drone 4 to fly forward. When the remote control is tilted backward, the gyroscope sensor senses a backward signal and sends the backward signal to the main control board 22, and the main control board 22 controls the drone 4 to fly backward. When the remote control is tilted leftward, the gyroscope sensor senses a leftward signal and sends the leftward signal to the main control board 22, and the main control board 22 controls the drone 4 to fly toward left. When the remote control 2 is tilted rightward, the gyroscope sensor senses a rightward signal and sends the rightward signal to the main control board 22, and the main control board 22 controls the drone 4 to fly toward right. By controlling the remote control 2 worn on the wrist, the flight path of the drone 4 is controlled in all directions, which improves operability and ease of use of the watch-type drone.

Optionally, in the embodiment, the remote control 2 further comprises a display 25 electrically communicated with the main control board 22. The display 25 is configured to display time. When the storage box 3 is removed, the remote control 2 of the embodiment is able to check the time, which increases functionality of the present disclosure. In addition, a size of a small drone is generally small, and a power supply thereof is relatively small, so a battery life is short. A battery life of the drone 4 of the present disclosure is up to 5 minutes. Therefore, when in use, a user is able to calculate a flight time by the time displayed on the display 25, so that a return time of the drone 4 is calculated and the drone 4 is prevented from falling and breaking due to insufficient power. The remote control 2 of the embodiment comprises a second power supply 27 configured to supply power to the main control board 22 and the display 25. A charging interface 28 configured to charge the second power supply 27 is arranged on a bottom portion of the remote control 2 to facilitate charging of the remote control 2.

At least two second fixing holes 217 matched with the watchband 1 are defined on the bottom portion of the remote control 2. The watchband 1 is a slap bracelet capable of automatically winding. The watchband 1 comprises a plastic layer and a memory metal shrapnel wrapped by the plastic layer. When in use, the watchband 1 is straightened into a straight slap bracelet and is inserted into the first fixing holes 217, and then a rear side of the slap bracelet is gently tapped on the wrist, then the watchband 1 is automatically rolled and wound on the wrist. Therefore, it is easy to replace the watchband 1 or a DIY watchband 1 made by the user can be used. Moreover, the watchband 1 is easy to wear and is wound on the wrist according to a size of the wrist of the user. Of course, in other embodiments, the watchband 1 may also comprise a non-woven layer arranged on an outer side of the watchband 1 and metal parts are arranged in two ends of the watchband 1, so that the watchband 1 of a non-woven structure easily passes through the second fixing holes 217. Velcro are arranged on the two ends of the watchband 1, so that the two ends of the watchband 1 are connected and the watchband 1 is worn on the wrist.

In the embodiment, the flight path and the flight speed of the drone 4 are controlled by the button assembly 23, and no additional remote control is needed to control the flight of the drone 4. Furthermore, the flight direction of the drone 4 is also controlled by controlling a tilt direction of the remote control 2 worn on the wrist, which is simple and convenient to operate. Optionally, a communication protocol between the remote control 2 and the drone 4 is selected from one of a WIFI protocol, a ZigBee protocol, and a GPRS protocol, so the remote control 2 of the present disclosure is able to control similar aircraft, remote control cars, and other toys. The remote control 2 and the storage box 3 where the drone 4 is accommodated are magnetically connected, so the drone 4 is replaced by assembling different storage boxes 3 accommodating different drones 4 on the remote control. Further, when the storage box 3 is removed, the user is able to check the time, so the present disclosure has multiple functions.

### Embodiment 2

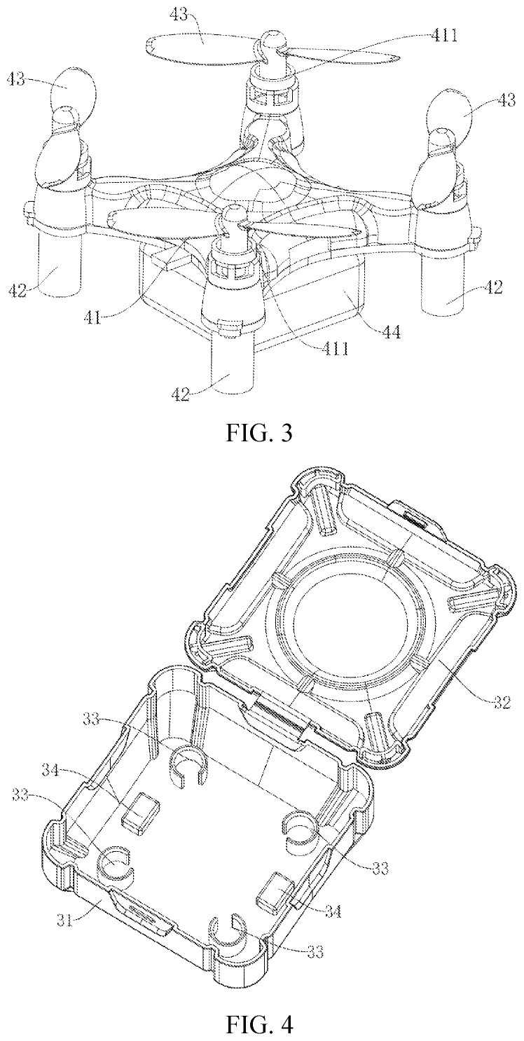

As shown in FIGS. 3-5, the present disclosure further provides another watch-type drone. The drone 4 comprises a fixing base 41. A printed circuit board (PCB) control board is arranged in the fixing base 41. First fixing holes 411 are defined on four corner directions of the fixing base 41. Four motors 42 are one-to-one mounted in the first fixing holes 411 and are communicated with the PCB control board. A rotor wing 43 is fixed on an output shaft arranged on a top portion of each of the motors 42. A first power supply 44 electrically connected to the PCB control board and the motors 42 is arranged on a bottom portion of the fixing base 41. Other structures of the watch-type drone are same as structures of the watch-type drone of the embodiment 1, which is not repeated herein.

When in use, the main control board 22 on the remote control 2 is communicated with the PCB control board 1 after code matching and calibration. By pressing the button assembly 23 on the remote control 2, the main control board 22 transmits control signals to the PCB control board, and the PCB control board controls the motors 42 to work according to received control signals, so as to drive each rotor wing 43 to rotate, and thereby controlling the flight path of the drone 4.

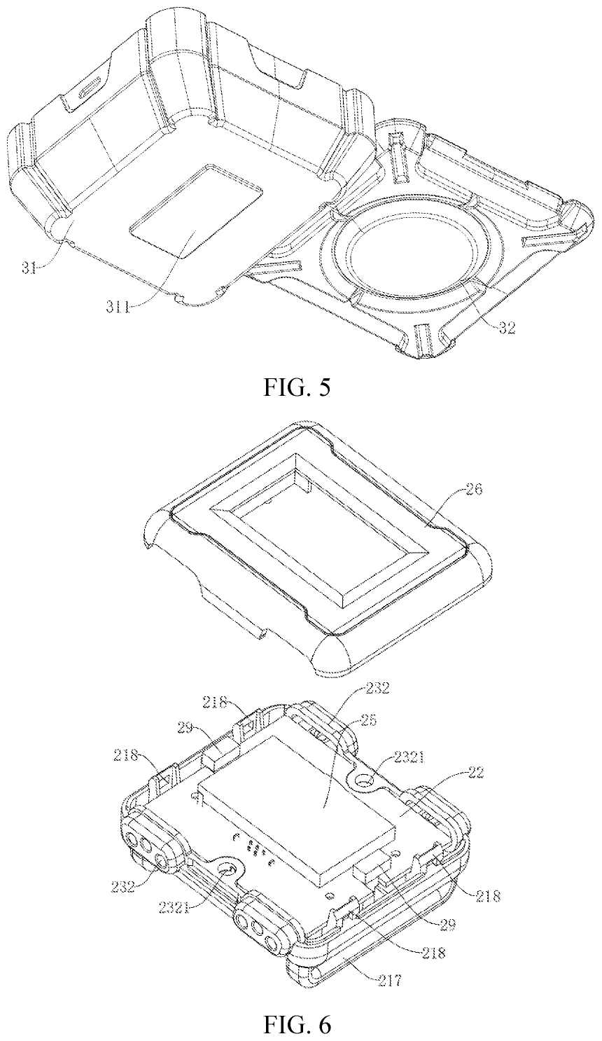

As shown in FIGS. 4-5, the storage box 3 comprises a box body 31 defining the receiving space and a cover body 32. The cover body 32 is fixed to a top portion of the box body 31 and is configured to seal the receiving space. Four circular fixing grooves 33 configured to position the motors 42 are defined in the receiving space. In addition, an opening is defined on each of the circular fixing grooves 33, so that the circular fixing grooves 33 have a certain deformation capacity, which facilitates fixing of the motors 42 in the circular fixing grooves 33. In addition, a rectangular positioning portion 311 is defined on the bottom portion of the storage box 31, and a second opening configured to fix the display 25 is defined on a top portion of the remote control 2. When the storage box 3 is magnetically connected to the remote control 2, the rectangular positioning portion 311 is fixed in the second opening defined on the top portion of the remote control 2, which is convenient for fixing and positioning of the remote control 2 and the storage box 3.

### Embodiment 3

As shown in FIGS. 6-10, the present disclosure further provides a remote control 2 applied to the drone 4 in the embodiment 1.

The remote control 2 comprises a lower shell 21 and an upper shell 26. The second fixing holes 217 are defined on the lower shell 21. The lower shell 21 and the upper shell 26 are connected to form the accommodating space and the through holes 24 on the two sides of the remote control 2. Four L-shaped positioning columns 211 are arranged on a middle portion of the lower shell 21 to form a rectangular fixing groove 212. The rectangular fixing groove 212 is configured to mount the second power supply 27. First cylindrical positioning columns 213 are respectively arranged on a left end and a right end of the lower shell 21. The first cylindrical positioning columns 213 are configured to fix the button assembly 23. Second cylindrical positioning columns are respectively arranged on a front end and a rear end of the lower shell. The second cylindrical positioning columns 214 are configured to fix the second magnets 29. A first bearing portion 215 is arranged on one side of each of the first cylindrical positioning columns 213 close to the rectangular fixing groove 212. Second bearing portions 216 are arranged on two sides of each of the second cylindrical positioning columns 214. The second opening configured to fix the display 25 is defined on a middle portion of the upper shell 26. Other structures of the remote control are same as structures of the remote control of the embodiment 1, which is not repeated herein.

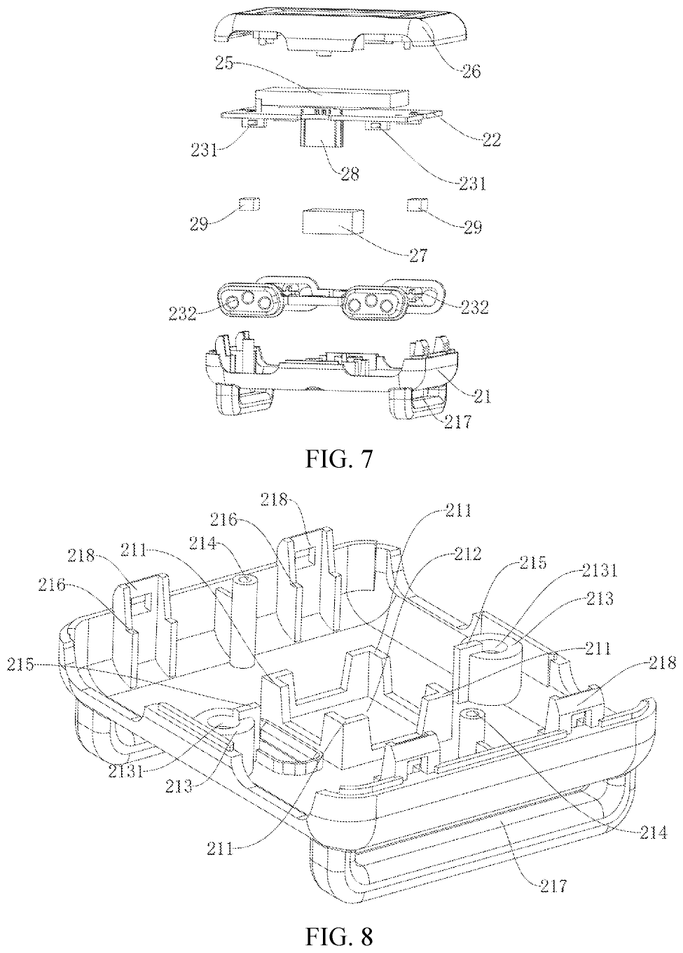

As shown in FIGS. 7-10, the button assembly 23 comprises button bodies 23 land two button cap assemblies 232. The button bodies 231 are arranged on two sides of the main control board and are communicated with the main control board. The button cap assemblies 232 are arranged on two ends of the remote control 2. Each of the button cap assemblies 232 comprises two button caps and button cap bodies connected to the two button caps. A mounting hole 2321 is defined on a middle portion of each of the button cap bodies. An inserting groove 2131 is defined on a middle portion of each of the first cylindrical positioning columns 213. Fixing columns 262 are arranged on a bottom portion of the upper shell 26. Each of the fixing columns 262 is matched with a corresponding inserting groove 2131.

Specifically, during installation, the second power supply 27 and the charging interface 28 are welded to a rear surface of the main control board 22, the display screen 25 is welded to a front surface of the main control board 22. Then the main control board 22 is mounted on the lower shell 21, and the second power supply 27 is fixed in the rectangular fixing groove 212. The charging interface 28 is fixed in the first opening. The middle portion of the main control board 22 is fixed to the top portions of the L-shaped positioning columns 211. The left side and the right side of the main control board 22 are respectively fixed to a top portion of a corresponding first bearing portion 215. The front side of the main control board 22 and the rear side of the main control board 22 are respectively fixed to the top portions of the second bearing portions 216. Then, each mounting hole 2321 of the two button cap assemblies 232 are aligned with a corresponding inserting groove 2131 of a corresponding first cylindrical positioning columns 213 arranged on the two sides of the remote control 2. Each of the second magnets 29 are fixed to a top portion of a corresponding second cylindrical positioning column 214. Then, the upper shell 26 is fastened to the lower shell 21, and at this time, each of the fixing columns 262 of the upper shell 26 passes through a corresponding mounting holes 2321 and is fixed in a corresponding inserting groove 2131, so that the button cap bodies are fixed in the accommodating space, the button caps respectively extends out from the through holes 24 on the two sides of the remote control, and the display 25 extends out of the second opening on the upper shell 26.

Optionally, hook portions 218 are arranged on the lower shell 21. Snap portions 261 matched with the hook portions 218 are arranged on the upper shell 26. The hook portions 218 are respectively snapped on the snap portions 261 to fixedly connect the lower shell 21 and the upper shell 26.

The remote control 2 of the present disclosure has a simple structure, is easy to assemble, is able to control the same kind of toys, and is able to check the time, so the remote control of the present disclosure has multiple functions.

### Embodiment 4

The present disclosure further provides an operating method of the watch-type drone mentioned above mentioned in the embodiment 1, the embodiment 2, and the embodiment 3. The operating method comprise:
S1: fixing the remote control 2 on the watchband 1, and then fixing the watchband 1 to a wrist;
S2: opening the storage box 3, taking out the drone 4, placing the drone 4 on a horizontal ground or on a platform, long pressing the button B and performing code matching and calibration on the drone 4; and completing the code matching and calibration of the drone after the drone 4 flashes a light and after the remote control 2 emits a beeping sound; and
S3: long pressing the button A, so the drone 4 is controlled to take off; short pressing the button A, so the drone 4 is controlled to rise; short pressing the button C, so the drone 4 is controlled to descend; pressing the button A and the button C, so the drone 4 is hovered at a required height and a flight height of the drone is controlled; short pressing the button A twice, so the drone 4 is controlled to fly forward in the fine-tuning mode; short pressing the button C twice, so the drone 4 is controlled to fly backward in the fine-tuning mode; short pressing the button B, so the drone 4 is controlled to rotate to the left or finely adjust to the left; short pressing the button D, so the drone 4 is controlled to rotate to the right or finely adjust to the right.

Therefore, the flight direction of the drone is controlled. When the button B and the button D are short pressed, the drone 4 is controlled to roll over. When the button B and the button D are long pressed, the remote control is controlled to enter the time adjustment mode. In addition, the remote control 2 of the present disclosure further comprises the gyroscope sensor, so the flight direction of the drone 4 is controlled by forward titling, left tilting, right tilting, or backward tilting of the remote control 2 worn on the wrist, which is convenient to operate. When the button C is short pressed, the drone 4 automatically descends to the horizontal ground or the platform. When the button A and the button C are long pressed, the drone 4 is turned off, When the button B and the button D are long pressed, the remote control 2 enters the time adjustment mode and the time displayed on the display 25 of the remote control 2 is adjusted. The remote control 2 of the present disclosure is simple and convenient to operate, the drone 4 is controlled to fly through the four buttons, or the flight direction of the drone 4 is controlled by tilting the remote control 2, and the remote controller 2. By long pressing the button C, other drones can be matched with the remote control and calibrated. Thus, the remote control is able to control toys with the same communication protocol, such as an aircraft, a remote control vehicle, etc. Therefore, the remote control 2 has multiple functions.

The above embodiments are optional embodiments of the present disclosure, but the embodiments of the present disclosure are not limited by the foregoing embodiments, and any other changes, modifications, substitutions, combinations, and simplification made without departing from the spirit and principle of the present disclosure should be regarded as equivalent replacement manners, which are all included within the protection scope of the present disclosure.

What is claimed is:

1. A watch-type drone, comprising:
a watchband,
a remote control detachably arranged on the watchband,
a storage box defining a receiving space, and
a drone placed in the receiving space;
wherein an accommodating space is defined in the remote control; a bottom portion of the storage box is magnetically connected to the remote control; the remote control comprises a main control board and a button assembly; the main control board is mounted in the accommodating space; the button assembly is mounted on two sides of the main control board and is electrically communicated with the main control board; through holes are defined on two sides of the remote control; the button assembly is exposed from the through holes; the button assembly is configured to control a flight path and a flight speed of the drone.

2. The watch-type drone according to claim 1, wherein the button assembly comprises a button A, a button B, a button C, and a button D; the button A and the button B are arranged on a first side of the remote control; the button C and the button D are arranged on a second side of the remote control; when the button B and the button D are short pressed: the drone is controlled to roll over; when the button B and the button D are long pressed, the remote control is controlled to enter a time adjustment mode; when the button A and the button C are short pressed, the drone is hovered; when the button A and the button C are long pressed, the drone is turned on/turned off.

3. The watch-type drone according to claim 2, wherein when the button A is short pressed, the drone is controlled to rise; when the button A is short pressed twice, the drone is controlled to fly forward in a fine-tuning mode; when the button A is long pressed, the drone is controlled to take off; when the button A is long pressed twice, the drone is controlled to land; when the button B is short pressed, the drone is controlled to rotate to left or finely adjust to the left; when the button B is long pressed, the drone is calibrated; when the button C is short pressed, the drone is controlled to descend; when the button C is short pressed twice, the drone is controlled to fly backward in the fine-tuning mode; when the button D is short pressed, the drone is controlled to rotate to right or finely adjust to the right; when the button D is short pressed, the flight speed of the drone is controlled to switch between a high speed mode and a low speed mode.

4. The watch-type drone according to claim 1, wherein the remote control further comprises a gyroscope sensor communicated with the main control board; during operation, when the remote control is tilted forward, the drone flies forward; when the remote control is tilted backward, the drone flies backward; when the remote control is tilted leftward, the remote control flies toward left; when the remote control is tilted rightward, the drone flies toward right.

5. The watch-type drone according to claim 1, wherein a communication protocol between the remote control and the drone is selected from one of a WIFI protocol, a ZigBee protocol, and a GPRS protocol.

6. The watch-type drone according to claim 1, wherein the drone comprises a fixing base; a printed circuit board (PCB) control board is arranged in the fixing base; first fixing holes are defined on four corner directions of the fixing base; four motors are one-to-one mounted in the first fixing holes and are communicated with the PCB control board; a rotor wing is fixed on an output shaft arranged on a top portion of each of the motors; a first power supply is arranged on a bottom portion of the fixing base; the first power supply is electrically connected to the PCB control board and the motors.

7. The watch-type drone according to claim 6, wherein the storage box comprises a box body defining the receiving space and a cover body; the cover body is fixed to a top portion of the box body and is configured to seal the receiving space; four circular fixing grooves configured to position the motors are defined in the receiving space.

8. The watch-type drone according to claim 7, wherein first magnets are arranged on a bottom portion of the box body; the first magnets are matched with second magnets arranged in the remote control.

9. The watch-type drone according to claim 1, wherein the watchband is windable to be worn on a wrist.

10. A remote control applied to the watch-type drone according to claim 2, wherein the remote control comprises a display electrically communicated with the main control board; the display is configured to display time.

11. The remote control according to claim 10, wherein the remote control comprises a second power supply; the second power supply is configured to power the main control board and the display; a charging interface configured to charge the second power supply is arranged on a bottom portion of the remote control.

12. The remote control according to claim 11, wherein second magnets are arranged in the remote control; the second magnets are magnetically connected with the storage box.

13. The remote control according to claim 12, wherein at least two second fixing holes matched with the watchband are defined on the bottom portion of the remote control; the watchband is inserted into the first fixing holes.

14. The remote control according to claim 13, wherein the remote control comprises a lower shell and an upper shell; the second fixing holes are defined on the lower shell; the lower shell and the upper shell are connected to form the accommodating space and the through holes on the two sides of the remote control; a first opening configured to mount the charging interface is defined on a bottom portion of the lower shell; four L-shaped positioning columns are arranged on a middle portion of the lower shell to form a rectangular fixing groove; the rectangular fixing groove is configured to mount the second power supply; first cylindrical positioning columns are respectively arranged on a left end of the lower shell and a right end of the lower shell; the first cylindrical positioning columns are configured to fix the button assembly; second cylindrical positioning columns are respectively arranged on a front end of the lower shell and a rear end of the lower shell; the second cylindrical positioning columns are configured to fix the second magnets; a first bearing portion is arranged on one side of each of the first cylindrical positioning columns close to the rectangular fixing groove; second bearing portions are arranged on two sides of each of the second cylindrical positioning columns; a middle portion of the main control board is fixed to top portions of the L-shaped positioning columns; a left side of the main control board and a right side of the main control board are respectively fixed to a top portion of a corresponding first bearing portion; a front side of the main control board and a rear side of the main control board are fixed to top portions of the second bearing portions; a second opening configured to fix the display is defined on a middle portion of the upper shell.

15. The remote control according to claim 14, wherein the button assembly comprises button bodies and two button cap assemblies; the button bodies are arranged on two sides of the main control board and are communicated with the main control board; the button cap assemblies are arranged on two ends of the remote control; each of the button cap assemblies comprises two button caps and button cap bodies connected to the two button caps; a mounting hole is defined on a middle portion of each of the button cap bodies; an inserting groove is defined on a middle portion of each of the first cylindrical positioning columns; fixing columns are arranged on a bottom portion of the upper shell; each of the fixing columns is matched with a corresponding inserting groove; each of the fixing columns passes through a corresponding mounting hole and is fixed in the corresponding inserting groove.

16. The remote control according to claim 15, wherein hook portions are arranged on the lower shell; snap portions matched with the hook portions are arranged on the upper shell; the hook portions are respectively snapped on the snap portions to fixedly connect the lower shell and the upper shell.

17. An operating method of the watch-type drone according to claim 3, comprising:
S1: fixing the remote control on the watchband, and then fixing the watchband to a wrist;
S2: opening the storage box, taking out the drone, placing the drone on a horizontal ground or on a platform, pressing the button B and performing code matching and calibration on the drone; and completing the code matching and calibration of the drone after the drone flashes a light and after the remote control emits a beeping sound; and
S3: long pressing the button A, so the drone is taken off; controlling the flight path of the drone by pressing different buttons.
